(19) United States
(12) Patent Application Publication
(10) Pub. No.: US 2009/0294577 A1
(43) Pub. Date: Dec. 3, 2009

(54) DEVICE FOR AUTONOMOUS MOVEMENT OF AN AIRCRAFT ON THE GROUND

(75) Inventors: Serge Roques, Cornebarrieu (FR); Didier Reynes, Toulouse (FR)

Correspondence Address: Perman & Green, LLP, 99 Hawley Lane, Stratford, CT, 06614, US

(73) Assignee: AIRBUS FRANCE, Toulouse (FR)

(21) Appl. No.: 12/306,669

(22) PCT Filed: Jun. 28, 2007
(86) PCT No.: PCT/FR2007/051545

§ 371 Date: May 1, 2009

(30) Foreign Application Priority Data
Jun. 28, 2006 (FR) 06 52689

(51) Int. Cl. B64C 25/50

(52) U.S. Cl. 244/50

(57) ABSTRACT

In order to allow an aircraft to move around autonomously on the ground, a system turns at least one wheel of the aircraft. The wheel is coupled to rotational drive means (4) comprising at least one motor coupled to said wheel by a mechanical transmission assembly (42) comprising a mechanical gearbox (6) the reduction ratio of which is continuously variable, for a limited angle of rotation of the wheel (10) of the aircraft, by means of spiral gears (61, 62) the radii of which vary continuously over practically a full revolution of said spiral gears and the reduction ratio of which is constant without limitation of the angle of rotation of the wheel (10) of the aircraft outside of said limited angle of rotation. The continuously variable reduction ratio is used to increase the torque supplied at start-up by the drive means without increasing the capability of the motor in order to be able to obtain the initial torque needed to set the wheels of the aircraft in rotation upon startup.

The present invention belongs to the field of moving aircraft on the ground. More particularly, the invention relates to a device designed to move the aircraft on the ground without requiring means external to the aircraft and without starting up the propulsion engines.

Outside the flight phases, aircraft must be able to be moved on the ground between various parking stands or between the take-off or landing areas and the parking stands.

To carry out these ground movements, aircraft are usually fitted with wheels, certain of which may be steerable. Depending on the circumstances, two methods of movement are currently used in the operation of civil aircraft.

A first method, usually used between the parking stands or to move the aircraft away from the airport terminals, consists in pulling or pushing the aircraft with ground means, for example a specific land vehicle using a drawbar.

The second method, widely used by aircraft for moving between a parking stand and a take-off or landing area, consists in using the aircraft's propulsion engines, propeller or jet engines, to create sufficient thrust on the aircraft to move it on its wheels.

The first method has the defect of requiring means, in materials and personnel, that are independent of the aircraft. For reasons of safety in particular, such means are not desirable in the areas on which aircraft move to reach a take-off area and their use is usually limited to the movements of the aircraft between the parking stands.

The second method, for its part, although it has the advantage of autonomy of the aircraft to provide its movement, is detrimental on several counts for the use of modern aircraft and for the operation of airports.

Specifically, on the ground, the propulsion engines of the aircraft are sources of noise and atmospheric pollution in the immediate environment of the airports, sources of pollution that are less and less tolerated. This pollution increases as the number of aircraft movements increases and as the size of airports require movement and waiting times for the aircraft which become increasingly long. Another consequence of the long movement and waiting times is the excessive consumption of fuel of the propulsion engines which may reduce the fuel provided for the flight and in extreme cases oblige the aircraft to return to its parking point to top up the quantity of fuel taken for the mission.

These problems have been known for a long time, even though, in the past, they have not been as critical and generalized as they are today, and various devices have been thought up to allow the aircraft to move autonomously without requiring the use of the propulsion engines.

It is therefore known to allow the aircraft to move on the ground by its own means to drive one or more wheels of the landing gear by means of a motor specific to this use.

Such a specific motor is for example an electric motor, an air motor or a hydraulic motor supplied by a power generator on board the aircraft.

Patent FR 2 065 734 proposes a solution for driving the wheels via a hydraulic motor which is arranged on the axis of a wheel and which, depending on the embodiment, may or may not have mechanical means for clutching and declutching the motor, and a set of associated pinions, and the wheel.

A disadvantage of such a device is associated in particular with the limitations of the hydraulic motor.

These limitations are three in number at least on board a conventional aircraft.

On the one hand, it is necessary to create a specific hydraulic circuit which may be restrictive for an installation on an aircraft because of the necessary powers and flow rates.

On the other hand, the hydraulic power is usually supplied on aircraft by the propulsion engines and operation with the propulsion engine stopped therefore involves installing a special generation, for example on an auxiliary power unit.

Finally, modern aircraft are fitted with wheels, the tires of which work with high inflation pressures, frequently greater than 15 bar, and a considerable static deflection of the order of 30% of the section of the tire, much greater than for a conventional land vehicle. For these reasons, the torque to be applied to the wheel to rotate the wheel from a stationary position is much greater than that which has to be applied when the aircraft is in a moving phase.

As a function of the characteristics of the tires and their loads, the ratio between the two torques may be as much as 3, and even exceed this value in particular situations.

It is therefore necessary for all of the motors and means of coupling said motors to the wheels, comprising a possible reduction gear, to be designed to supply the necessary torque to start the movement which leads to an overengineered assembly during the movement.

The drive motor of the wheel may also be an air motor but, in this case, the torques and the powers that have to be developed require considerable flow rates of air which are detrimental to the installation of the device because of the diameters of the hoses necessary for transporting the air and the risks of bursting associated with the high pressures. In addition, the escape of air at the outlet of the motor is a source of noise pollution which goes against the problem to be solved.

The drive motor of the wheel may also be an electric motor but, although the torque of an electric motor can be modified in operation by acting on the electric power supply of said motor, it is difficult to vary said torque in the whole range necessary without designing the drive means beyond that which is necessary for established moving.

In order to provide the autonomous movement of an aircraft on the ground without using the force generated by the propulsion engines, the invention proposes a device for driving at least one wheel of an aircraft by a motor associated with the wheel and in which said motor is coupled to said wheel by drive means comprising a mechanical reduction gear of which the reduction ratio is continuously variable, for a limited angle of rotation of the wheel of the aircraft, by means of spiral gears with continuously variable radii over substantially one revolution of said spiral gears and of which the reduction ratio is constant outside said limited angle of rotation, so that the torque delivered to the wheel of the aircraft by the drive means is higher on startup of the movement of the aircraft than during the established movement with a motor the torque of which is essentially determined by the conditions of established movement.

Preferably, the continuously variable reduction ratio for a limited angle of rotation of the wheel of the aircraft decreases between a first extreme position when the wheel of the aircraft is immobile and a second extreme position when the wheel of the aircraft is rotated beyond the limited angle of rotation to ensure a continuous transition between the stopped position of the aircraft and the established movement of said aircraft.

In order to prevent a discontinuity of the torque when the drive means are engaged in the method with constant reduction ratio, the continuously variable reduction ratio, when the drive means are at the second extreme position, is substantially equal to the constant reduction ratio.

In one embodiment which makes it possible to limit the dimensions of the rotated reduction assembly, the transition from the variable reduction ratio method to the constant reduction ratio method is achieved by means of a mechanical reduction gear which comprises selection means, clutches and/or keys, to pass from the continuously variable reduction ratio transmission method to the constant reduction ratio transmission method.

In another embodiment which avoids the use of coupling means comprising selection means such as keys or clutches, one of the spiral gears is secured to a reduction gear of which:
the reduction ratio is constant and substantially equal to the lowest reduction ratio of the spiral gears, and
the axis of an input shaft of said reduction gear is colinear with the axis of an output shaft secured to a spiral gear, and
the spiral gears comprise stops which immobilize said spiral gears relative to one another when the drive means are in the second extreme position, and
said reduction gear and the spiral gears are secured to a support, such as a shroud or a reduction gearbox case, capable of being driven in an overall rotational movement about the axis of the input and output shafts so that the output shaft is rotated at the speed of the input shaft.

In order to adapt the dimension of the motor or motors of the drive means simultaneously to the conditions of setting in motion and of established movement, the reduction ratio of the continuously variable mechanical reduction gear varies between the two extreme positions substantially in the ratio of the drive torques necessary, on the one hand, to provide the established movement of the aircraft and, on the other hand, to set the aircraft in motion from a static position.

Preferably, to limit the weight of the drive means that are installed on the aircraft, only one wheel of the aircraft is rotated to move the aircraft or, when the force to be developed cannot be generated by the contact of a single wheel, two or more wheels are rotated to move the aircraft.

Depending on the force to be transmitted, the aircraft wheel or wheels are wheels of a front landing gear or else wheels of a main landing gear of the aircraft, preferably a front landing gear because of the greater simplicity of the front landing gears that are usually not fitted with brakes.

Depending on the energy available on board the aircraft, in particular the energy delivered by an auxiliary power unit, the rotated wheel or wheels are driven by means of one or more electric motors, one or more hydraulic motors, or one or more air motors.

In order to limit the mechanical stresses in the drive means when the aircraft is in motion without the use of the autonomous drive device according to the invention, advantageously the drive means are capable of being decoupled from the wheels, preferably as close as possible to the wheel, for example by means of a clutch device.

In order to limit the mechanical stresses in the drive means, in particular at the time when the wheels begin to rotate during landing of the aircraft, the wheel or wheels that are rotated to move the aircraft have, at least temporarily when said wheels are not moving the aircraft, their speeds of rotation slaved to the speed of the aircraft relative to the ground so that the tangential speed of said wheels is substantially equal to the speed of the aircraft relative to the ground.

Preferably, to prevent the propulsion engines from being in operation while the aircraft is moved, the energy necessary to move the aircraft is generated by at least one auxiliary power unit.

In a particular or alternate operating method, the energy necessary to move the aircraft is generated by at least one propulsion engine of the aircraft, for example when said propulsion engine is necessarily operating during an approach phase preceding a landing of the aircraft or when at least one engine is operating at idle speed on the ground.

The operation of the drive motor or motors is managed by command and control means comprising a control in the cockpit, said control in the cockpit advantageously being an existing control such as the control for controlling the power of the propulsion engines.

The detailed description of one embodiment of the invention is given with reference to the figures which represent:

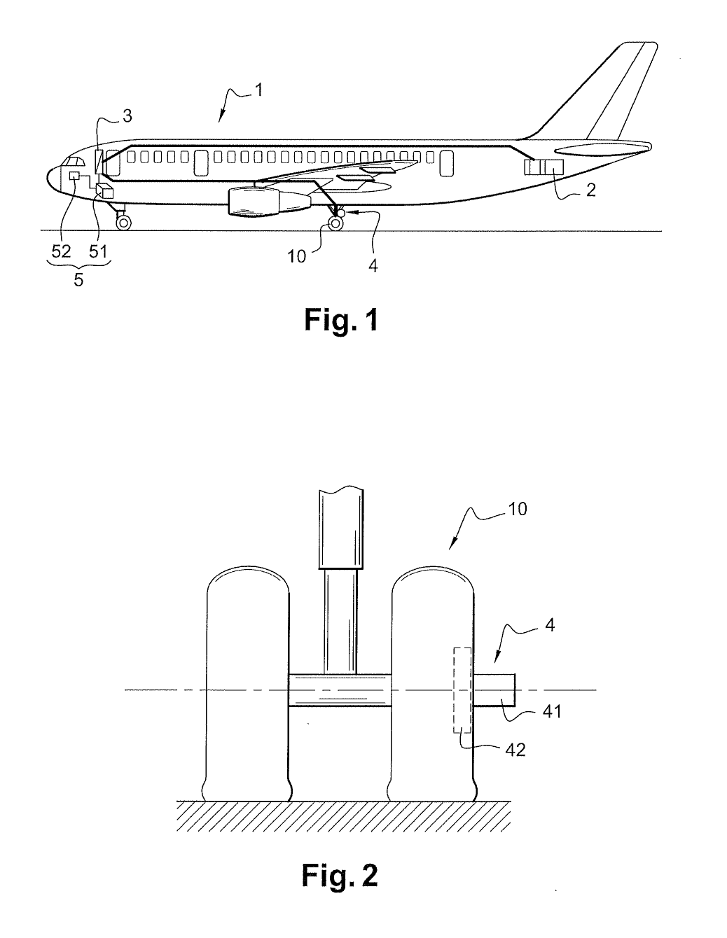

FIG. 1: a diagram of a system according to the invention and of its main elements on board an aircraft;

FIG. 2: a diagram of a wheel fitted with drive means;

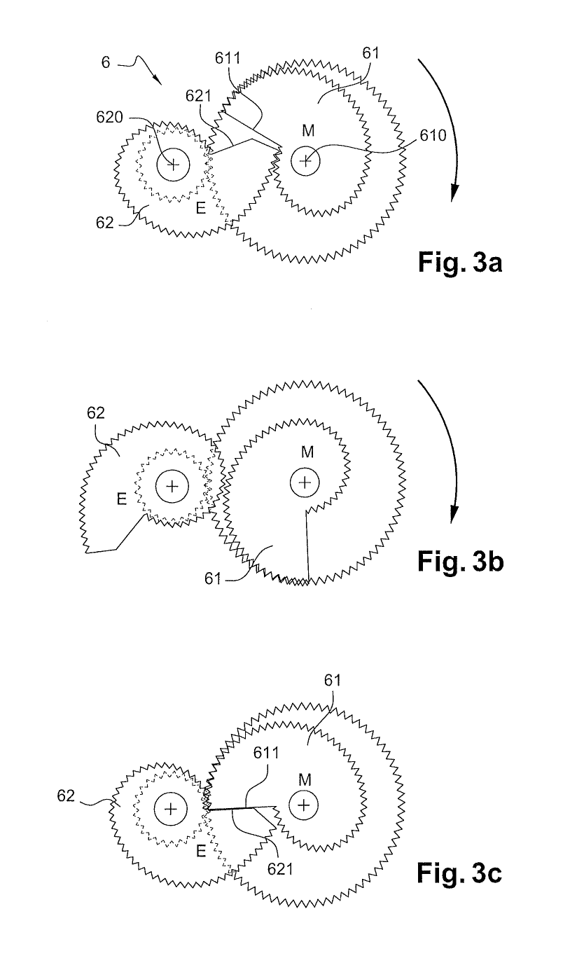

FIG. 3: the operating principle of a continuously variable reduction ratio reduction gear;

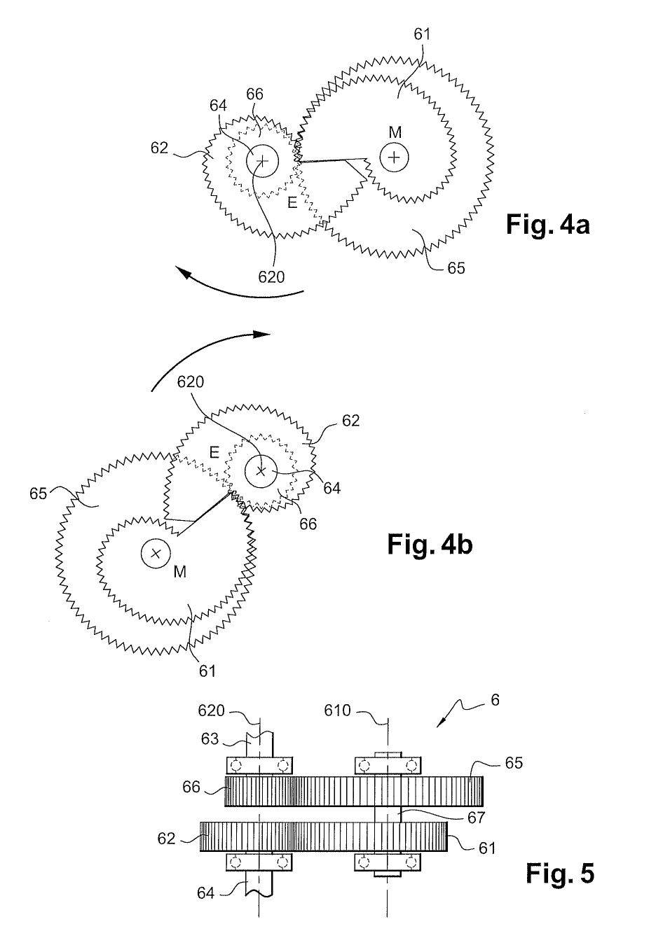

FIG. 4: the reduction gear of FIG. 3 in an operating mode in which the output shaft is driven at the same speed as the input shaft;

FIG. 5: a schematic view of the reduction gear of FIGS. 3 and 4 showing the arrangement of the drive gears and of the various transmission shafts.

In the exemplary embodiment of FIG. 1, a device for the autonomous movement of an aircraft 1 on the ground without requiring the use of the propulsion engines comprises:

a—at least one source of power 2 onboard the aircraft capable of delivering sufficient electric power to move the aircraft;

b—means 4 for driving at least one wheel 10 of the aircraft, said drive means comprising at least one electric motor 41;

c—means 3 for distributing electric power;

d—means 5 for commanding and controlling the device.

The source of power 2 is advantageously an auxiliary power unit, called APU, which, on most modern aircraft, is already used to supply the aircraft with compressed air and electricity when the latter is not connected to the ground sources and when no propulsion engine is operating. The auxiliary power unit is capable of delivering at least the power necessary to ensure the continuous movement of the aircraft and if necessary to exceed the forces necessary to overcome the static deformation of the tires and to start the movement if a greater power is necessary for this movement-startup phase. This power is a function of the characteristics specific to each aircraft model and of the means of coupling between the electric motor or motors and the rotated wheel or wheels.

In one simple embodiment, the drive means 4 comprise an electric motor 41 coupled to a wheel 10 by means of a mechanical transmission assembly 42.

The coupling may be achieved by any known means, for example by friction of a roller rotated on the tire of the wheel or on a determined zone of the rim of the wheel, by chains, by belts, by toothed pinions, etc.

Said mechanical transmission assembly 42 comprises, between the electric motor 41 and the wheel 10 of the aircraft, a mechanical reduction gear 6, the principle of which is shown in FIGS. 3, 4 and 5, with a continuously variable reduction ratio by means of drive gears 61, 62 each rotating about an axis of rotation, respectively 610, 620, for example gears furnished with teeth, and in which the distance from the periphery to the axis of rotation varies continuously over one revolution of said gears or over a fraction of a revolution. The periphery of said gears follows a portion of a spiral so that over one revolution, or over a fraction of a revolution, of said gears, which are identified in the rest of the description as the spiral gears, the reduction ratio between the rotation shafts of the two gears varies according to the relative angular position of the two spiral gears in a ratio chosen and determined by the parameters of the spiral. Such reduction gears with continuously variable reduction ratios are known. Patent U.S. Pat. No. 3,098,399 describes an exemplary embodiment using such a reduction gear.

Said transmission assembly also comprises means, not shown, for example clutches or systems with keys, which make it possible to decouple the reduction gear 6 with a continuously variable reduction ratio from the wheel 10 and to couple the electric motor 41 to the wheel 10 with no reduction ratio or with a constant reduction ratio. Such means are known and used in mechanical transmission devices and they may take very varied forms.

Said transmission assembly also comprises, when the complete decoupling of the drive means of the driven wheel is desired in certain operating modes of the aircraft, coupling/decoupling means, not shown, which make it possible to mechanically separate the transmission assembly and the wheel. These coupling/decoupling means take for example the form of clutches or of means for moving drive rollers or pinions.

In the present mechanical transmission assembly 42, when the electric motor 41 rotates in one direction from a stopped position of the aircraft 1, the continuously variable reduction ratio reduction gear 6 is in a position shown in FIG. 3a corresponding to the biggest reduction ratio of said assembly, that is to say that the driving spiral gear 61 is in contact on its smallest radius with the spiral driven gear 62 on its largest radius. Gradually during the rotation of the spiral gear 61 driven by the motor, called the driving spiral gear or M, the reduction ratio of the transmission assembly reduces as shown in FIG. 3b because of the change in the radii between the spiral gear M 61 and the spiral gear 62 driven by the gear M, called the driven spiral gear or E, corresponding to the point of contact between said gears, until the extreme position is reached, shown in FIG. 3c in which the reduction ratio of the continuously variable ratio reduction gear 6 is minimal. The configuration of the mechanical transmission assembly is then modified in order to use a constant reduction ratio between the motor 41 and the wheel 10.

Preferably, the characteristics of the elements used to produce the transmission assembly 42 are chosen so that the reduction ratio in the configuration with a constant reduction ratio corresponds substantially to the lowest reduction ratio of the configuration with continuously variable ratio, that is to say when said assembly 42 passes from the variable mode to the constant mode. This choice of the reduction ratios makes it possible to ensure a transition with no notable sudden variation in the torque at the time of the change of mode, a variation which would adversely affect the comfort of the passengers of the aircraft and the mechanical strength of the drive means 4.

In a particular embodiment, the spiral gears 61, 62 of the continuously variable reduction ratio reduction gear comprise stops 611, 621 so that, when the minimum reduction ratio is reached, the situation shown in FIG. 3c, the spiral gears are immobilized relative to one another and are, when the choice is made not to use means for decoupling the variable reduction ratio reduction gear, driven in an overall rotary motion, as shown in FIGS. 4a and 4b, by the electric motor 41.

For this, the reduction gear 6 with continuously variable reduction ratio comprises an input shaft 63 on the side of the motor 41 and an output shaft 64 on the side of the wheel 10 whose axes are in line. This result is obtained by means of a reduction assembly whose reduction ratio is the inverse of that obtained by means of the spiral gears when the latter reach their stops.

In the arrangement proposed in FIG. 5, which also corresponds to FIGS. 3 and 4, the spiral gear M is secured by means of a common rotation shaft 67 to a constant-radius gear 65 driven by a constant-radius gear 66 secured to the input shaft 63. The constant-radius gears 65, 66 form a reduction gear, the reduction ratio of which is a function of the value of the radii. The input shaft 63 and output shaft 64 and the common shaft 67 are kept in bearings or rolling bearings secured to a retention structure, for example a casing, not shown in the figures.

When the two spiral gears 61, 62 are immobilized relative to one another, the constant-radius gears 65, 66 are also immobilized relative to one another and relative to the spiral gears. The input shaft 63 and output shaft 64 are then secured because of the immobilization of the relative positions of the various gears and rotate at the same speed, as does the retention structure, about the axis 620 common to the two shafts, input 63 and output 64. This arrangement makes it possible to avoid the mechanical clutch means for passing from the transmission mode with variable reduction ratio to the transmission mode with constant reduction ratio.

Other arrangements of the various shafts and pinions are possible to achieve the same result, for example with an input shaft secured to the spiral gear M 61, an output shaft secured to the constant-radius gear 65 and a connecting shaft between the spiral gear E 62 and the constant-radius gear 66.

Advantageously, the constant-radius gears 65, 66 are pinions of a gear pair and the radius of the gear 66 secured to the input shaft 63 is equal to the smallest radius of the spiral gear E 62 and the radius of the gear 65 secured to the spiral gear M 61 is equal to the largest radius of the spiral gear M such that the output shaft 64 rotates at the same speed as the input shaft 63 when spiral gears 61, 62 and the stops 611, 612 come into contact.

When the aircraft is not driven by the drive device, the drive means are preferably decoupled from the wheel so as not to generate resistance torque and not risk being damaged, in particular by the wheels starting to rotate rapidly on landing.

In an alternate embodiment, the drive means are permanently coupled to the wheel and, when the situation requires, the drive device is slaved to the ground speed of the aircraft such that the motor drives the coupled wheel so that its tangential speed corresponds to the speed of the aircraft relative to the ground. This method is advantageously used before landing so that, when the wheel coupled to the drive means touches the ground, the latter is already rotating and does not sustain any sudden acceleration capable of damaging the drive means, motor or mechanical reduction gear. In this particular mode of operation, the propulsion engines are operating and are advantageously used as a source of power to generate the electric energy necessary for the device. In addition, the necessary power is relatively moderate since the wheels are not yet in contact with the ground and starting them rotating does not involve moving the weight of the aircraft.

The drive means are connected to the source of electric energy generation 2 via electric switching means, contactors or static relays, suitable for the powers in question. Advantageously, said switching means are connected to the electric energy distribution network of the aircraft which makes it possible to use the auxiliary power unit 2 as a source of energy but, if necessary, other sources such as those associated with the engines, in particular in the landing phases as already considered.

Depending on the technology used for the electric motor 41, the latter is torque- and speed-controlled by a control computer 51 which acts on the supply of the motor according to the parameters originating from other systems of the aircraft, and of which the main ones are explained in the rest of the description. Said control computer and/or other means of the aircraft 1 with which it has a functional link also act on the systems of the aircraft which interact with the device, during the movement or its preparation.

In order to control the operation of the device, the latter receives notably:
information relating to the state of the aircraft and to its status, for example “on the ground” or “in flight”;
information on the state of the various systems and of the resources that are necessary to the correct and safe operation of the device. This information relates to the availability of the electric energy, but also to the activation of certain other systems, notably the braking system which must imperatively be operational when the aircraft moves alone for safety reasons;
an item of information equivalent to a speed setpoint or to a force of movement. In a primary operating mode, this information corresponds to an instruction given by the aircraft crew which commands the movement. Advantageously, the control member 52 used in flight to control thrust or power of the propulsion engines, said propulsion engines being stopped, is used to generate this item of information which has the advantage of not requiring additional controls to be put in place in the cockpit and not modifying the behavior of the crew which, in most aircraft, uses this control to control the thrust of the propulsion engines during movement. In an operating mode of a higher level, the information is generated by an automatic movement system which is capable of managing movements of the aircraft on the ground, for example as a function of ground traffic information. When the propulsion engines are operating, in particular in a landing phase or a phase of movement with the engines, and the drive means are not declutched, the information advantageously corresponds to a wheel-speed setpoint which minimizes the forces in the drive means to prevent damaging said means;
the relative positions of the spiral gears 61, 62 which determine the reduction ratio of the drive means 4 and of the various clutch means if such means are used.

In addition to controlling the energy supply of the motor 41 of the drive means 4, the computer 51 generates the instructions to any means for clutching/declutching the drive means. Said computer also transmits to the aircraft's other systems the information on the operation of the device, for example speed of the driven wheel, electric power, etc.

The electric power needed for movement on the ground is an important feature of the device and a system for managing the electric energy of the aircraft advantageously uses this parameter in real time if necessary to lighten the electric loads of the aircraft that are not essential during the movement, for example certain loads corresponding to comfort equipment.

In order to optimize the power of electric generation necessary for the device, a first step consists in determining the power necessary for moving the aircraft 1 in the established regime. Such an established regime is specified by the operational needs of the aircraft, for example a traveling speed of 25 km/h (approximately 7 m/s) on a 2% slope at the maximum (performance reductions may be tolerated when one of these values is exceeded), and by the characteristics specific to the aircraft and its landing gear, in particular the number, the dimensions and the inflation pressure of the tires.

For the low speeds for moving a civil aircraft, the force to be developed to ensure movement on horizontal ground in the established regime is of the order of 1.6% of the weight moved.

For example, for an aircraft of 77 tonnes' weight in movement, the force to be exerted during established movement is of the order of 1250 DaN on horizontal ground, without acceleration, a force to which should be added the force corresponding to the slope, namely substantially 1550 DaN for 2% of slope.

The total power to be developed by the electric motors to move the aircraft at 25 km/h (˜7 m/s) is therefore of the order of 200 kW.

The torque per wheel is of the order of 7 KN.m for example on the assumption of two wheels (fitted with 49-inch tires, or approximately 0.51 m of radius under load) of the main landing gear fitted with electric motors.

In a second step, the electric motor or motors being determined for established movement, the maximum torque that the electric motor is capable of delivering on startup, the torque which depends on the technology used for the motor, is compared with the initial torque necessary to overcome the startup forces associated with the portion of the static deformation of the tires under load and the force to be developed to accelerate the aircraft up to the established movement speed. This initial torque is in practice of the order of three times, variable depending on the characteristics of the tires, the torque necessary in continuous movement on horizontal ground, namely in the example used, 21 KN.m on the axis of each of the two wheels (in the chosen example) driven by motors. This ratio of three between the two extreme torques sought is obtained with a reduction gear comprising two spiral gears as described without increasing the capacity of the motor to develop a higher torque than in the established movement phase.

If the ratio between the torque on startup and the torque during movement is greater, the reduction gear with continuously variable reduction ratio advantageously comprises two stages of spiral gears in order to produce a reduction ratio that varies for example in a ratio of nine.

The driven wheel or wheels are wheels of the main landing gear and/or of the front landing gear.

Other embodiments or applications of the invention are possible.

For example, the electric motor 41 may be replaced by a motor using another source of energy, hydraulic or air for example, if this energy is available without an unacceptable penalty.

The energy may also be produced by a propulsion engine which, in particular during movement on the ground, is adjusted as close as possible to the idling power to limit noise and pollution.

The invention therefore makes it possible to produce an autonomous aircraft during its movements on the ground by means of a movement system which makes it possible to prevent the disadvantages of movement using the propulsion engines of the aircraft and which prevents most of the disadvantages of the systems already conceived and which, to the inventor's knowledge, have never been applied.

1. A system for moving an aircraft on the ground autonomously in which at least one wheel of said aircraft is coupled by a mechanical transmission assembly comprising a mechanical reduction gear with means for driving in rotation comprising at least one motor, characterized in that the mechanical reduction gear has a continuously variable reduction ratio between two extreme positions, for a limited angle of rotation of the wheel of the aircraft, by means of spiral gears hose radii vary continuously over substantially one revolution of said spiral gears and of which the reduction ratio is constant without limitation of the angle of rotation of the wheel of the aircraft outside said limited angle of rotation, and characterized in that the reduction ratio between the two extreme positions is substantially in a torque ratio corresponding to the drive torques necessary, on the one hand, to provide the established movement of the aircraft and, on the other hand, to set the aircraft in motion from a static position.

2. The system as claimed in claim 1, wherein the continuously variable reduction ratio for a limited angle of rotation of the wheel of the aircraft decreases between a first extreme position when the wheel of the aircraft is immobile and a second extreme position when the wheel of the aircraft is rotated beyond the limited angle of rotation.

3. The system as claimed in claim 2, wherein the continuously variable reduction ratio, when the drive means are at the second extreme position, is substantially equal to the constant reduction ratio.

4. The system as claimed in claim 1, wherein the mechanical reduction gear comprises selection means, clutches and keys, in order to couple the motor to the wheel of the aircraft either with the transmission means with continuously variable reduction ratio or with the means with constant reduction ratio.

5. The system as claimed in claim 1, wherein one of the spiral gears is secured to a reduction gear wherein:
the reduction ratio is constant and substantially equal to the lowest reduction ratio of the spiral gears, and
the axis of an input shaft of said reduction gear is colinear with the axis of an output shaft secured to a spiral gear, and
the spiral gears comprise stops which immobilize said spiral gears relative to one another when the drive means are in the second extreme position, and
said reduction gear and the spiral gears are secured to a support capable of being driven in an overall rotational movement about the axis of the input and output shafts so that the output shaft is rotated at the speed of the input shaft.

6. The system as claimed in claim 1, wherein only one wheel of the aircraft is rotated to move the aircraft.

7. The system as claimed in claim 1, wherein two or more wheels are rotated to move the aircraft.

8. The system as claimed in claim 1, wherein at least one wheel of a front landing gear of the aircraft is rotated.

9. The system as claimed in claim 1, wherein at least one wheel of a main landing gear of the aircraft is rotated.

10. The system as claimed in claim 1, wherein the rotated wheel or wheels are driven by means of one or more electric motors.

11. The system as claimed in claim 1, wherein the rotated wheel or wheels are driven by means of one or more hydraulic motors.

12. The system as claimed in claim 1, wherein the rotated wheel or wheels are driven by means of one or more air motors.

13. The system as claimed in claim 1, wherein the means for driving in rotation are capable of being decoupled from the wheels so that the rotation of one wheel does not drive said drive means.

14. The system as claimed in claim 1, wherein the wheel or wheels that are rotated to move the aircraft have, at least temporarily when said wheels are not moving the aircraft, their speeds of rotation slaved to the speed of the aircraft relative to the ground so that the tangential speed of said wheels is substantially equal to the speed of the aircraft relative to the ground.

15. The system as claimed in claim 1, wherein the energy necessary to move the aircraft is generated by an auxiliary power unit.

16. The system as claimed in claim 1, wherein the energy necessary to move the aircraft is generated, at least for certain conditions of use of the system, by at least one propulsion engine of the aircraft.

17. The system as claimed in claim 1, wherein the operation of the drive motor or motors is managed by command and control means comprising a control in the cockpit.

18. The system as claimed in claim 17, wherein the control for controlling the power of the propulsion engines is used as a control for the command and control means.
